(19) United States
(12) Patent Application Publication
(10) Pub. No.: US 2010/0005933 A1
(43) Pub. Date: Jan. 14, 2010

(54) Wire nut tool

(76) Inventor: Kevin Cline, Medina, OH (US)

Correspondence Address: Bradley D. Goldizen, HC 80 BOX 261, Maysville, WV, 26833, US

(21) Appl. No.: 12/319,600

(22) Filed: Jan. 8, 2009

Related U.S. Application Data
(60) Provisional application No. 61/134,830, filed on Jul. 14, 2008.

(51) Int. Cl. B25B 13/06; B25B 13/46

(52) U.S. Cl. 81/124.3; 81/60

(57) ABSTRACT

A tool for installing a wire nut connector onto at least two wires includes an injection molded device having an orifice arranged on a distal face of the device for accepting a wire nut. This wire nut orifice includes a through opening and a plurality of curved regions arranged therein for contacting ridges on an exterior of the wire nuts during installation and removal. Pairs of stepped shoulders are arranged within the wire nut orifice for accepting wings on an exterior of the wire nuts. In a first embodiment, the tool includes a rotating handle. In a second embodiment the device includes a square opening on the proximal face for accepting an end of a ratcheting drive.

The present application relates to U.S. Provisional Patent Application Ser. No. 61/134,830 filed on Jul. 14, 2008 and claims priority therefrom.

The present invention did not receive federal research and development funding.

### TECHNICAL FIELD

Generally, the present invention relates to a wire nut tool comprising a shaft coupled to a handle on one end and a second end of the shaft being coupled to a body such that the body may be rotated around the shaft. The body of the wire nut tool comprises an opening that receives a wire nut. Wires that are to be coupled together to create a circuit connection are inserted into the wire nut and the handle is rotated in a clockwise manner about the wire nut to create a twisting action on the wire nut to couple the wires together. The handle spins relative to the body to create a stronger torque with much less force exerted than in tools requiring the twisting action such as when using a screwdriver. Moreover, the force is exerted by rotation of the hand about a point via the larger forearm and upper arm muscles while and preventing injuries caused by twisting action of the wrist and its associated smaller muscle groups. Thus, the wire nut tool is used by rotating the handle about an axis of rotation used to spin wire nuts onto electrical wires to create an electrical connection between the wires. More particularly, the present invention is a wire nut tool adapted to receive wire nuts of different sizes and shapes. In a preferred embodiment, the wire nut tool comprises nonconductive or insulated materials which protect the user from experiencing an electrical shock.

### BACKGROUND OF THE INVENTION

For years, electricians have used wire nuts for connecting electrical wires together. The electrician typically twists the wires together and cuts the ends with electrician's pliers. Thereafter, a wire nut is installed onto the wires to maintain electrical continuity between them. For purposes of this disclosure, “wire nut” is given its ordinary meaning as understood by a licensed electrician. Wire nuts are made up of an elongated shell, covered with pliable insulation. The shell is enclosed at only one end. The other end of the shell is longitudinally hollow with a threaded metal connecting socket coupled within the hollowed shell. Typically, the connecting socket is comprised of a conductive material such as metal or aluminum. Many wire nuts also have outwardly extending wings, which aid in gripping and turning the wire nut during installation. Other wire nuts can come without wings and typically include raised ridges on the exterior for aiding in gripping the wire nut when installing or removing them. Wire nuts are available in many different sizes and shapes. For purposes of this disclosure, the terms “proximal” and “distal” are defined with respect to the handle of the tool.

Generally, wire nuts are manually connected onto the ends of the wires to electrically and mechanically couple the wires together. To connect two or more wires using a wire nut, the user aligns the ends of the wires so they are even, then the wire nut is placed over the ends of the wires and twisted by hand until secure. The wires become threaded within the socket of the wire nut and twist or are pressed together creating electrical continuity between the wires. To obtain an effective connection, a great deal of pressure must normally be applied by hand, and more specifically, by the user's fingers which can cause calluses, cramps, tenderness, numbness and/or tingling. The repetitive action involved in manually connecting a large number of wire nuts can even result in the user being afflicted by carpel tunnel syndrome. If ample pressure is not applied, the wire nut will not be connected securely. Loose wire nuts may cause circuit failure and/or electrical arching within the wire nut which tends to melt the plastic shell of the wire nut and may lead to a fire. In wiring a single building, electricians install large numbers of wire nuts by hand which is slow and tedious.

Other wire nut tools have helped solve some of these problems, but not enough to be accepted by all in the field. Prior art wire nut tools are often bulky and/or ineffective. The use of pliers on wire nuts can result in cracking of the plastic shell and a consequent risk of open circuits. Some wire nut wrenches are time consuming to use due to the wire nut becoming jammed in the tool. These wrenches generally result in a longer installation time than if the wire nuts had just been manually installed. Other wrenches only install one or two types of wire nuts. Electricians and other users are thus forced to carry multiple wire nut tools. Finally, some wrenches are fabricated from metal or aluminum, which raises the risk that the installer will experience an electrical shock when applying the wire nuts to electrical wires.

By way of example, some of the prior art devices that have been used to install wire nuts include U.S. Pat. No. 4,860,618 to Givot. Givot discloses a generally cylindrical in shape tool sized to fit a normal sized hand. The cylinder has a wire nut receptacle opening in the base. A wire nut is inserted into the receptacle and is secured to the wires. In a second embodiment, two receptacles are include with one placed on each end of the cylinder. The receptacles are sized to accommodate different styles of wire connectors. Third and fourth embodiments are identical to the first and second except for the addition of a ratchet mechanism installed within the body of the cylinder.

U.S. Pat. No. 5,806,382 to Hall, Jr. discloses a wire end connector tool designed for use with a standard wire connector cap for crimping the ends of wires together. The tool consists of a cylindrical handle of a thickness to fit comfortably in a user's hand and an axial member longer than the handle, rotationally captured in and extending through the cylindrical handle and able to rotate therein. One or both ends of the axial member protrude from the end(s) of the cylindrical handle. Each protruding end is formed into a helical coil with its axis parallel to, but spaced from, the axis of the handle. Each coil is designed to securely accept standard wire connector caps such as those described above and to prevent it from rotating. This allows wires to be connected with a simple wrist rotation rather than requiring manual twisting with the fingers.

U.S. Pat. No. 5,974,916 to Lassiter discloses a wire nut driver including a ratchet ball which drives a socket. The ratchet ball is formed with a center opening which allows the ratchet ball to receive a stem of the socket in either end thereof for rotation in either the clockwise or counterclockwise direction. The socket is formed with a center bore. The center bore is formed by a plurality of alternating channels and ribs which engage complementary shaped channels and ribs of a wire nut. Rotation of the ratchet ball produces rotation of the socket and wire nut for attaching the wire nut to a plurality of wires for electrically connecting the wires together. A pair of slots are formed in an open end of the socket adjacent the center bore for receiving a wing nut-type wire nut. The inner surface of the center bore may be stepped or tapered to receive various sizes of wire nuts.

None of the prior art wire nut tools have alleviated the present difficulties of installing wire nuts efficiently and safely. Consequently, most wire nuts are still installed by hand. A more efficient means is needed for greater ease and to speed-up the installation process. To that end, the instant application aims to provide a novel tool that comprises an offset opening that receives a wire nut for installation through a rotation of the handle about an axis of rotation that intersects the center of both ends of the wire nut being installed.

### SUMMARY OF THE INVENTION

The wire nut tool of the present invention is designed to install or remove wire nuts simply and expeditiously by spinning the wire nuts on or off electrical wires by rotating the handle of the wire nut tool and the body of a wire nut tool about a central axis defined by a wire nut situated within a wire nut opening in the body of the wire nut tool.

The present invention, in a first embodiment includes a handle, a wire nut holder body, and a shaft extending from the holder body which is received within a shaft aperture formed in the handle that allows the handle to rotate relative to the holder body. The holder body contains a wire nut aperture that is offset from an axis that extends through the center of the handle and shaft and which receives the wire nuts. The wire nut aperture has a plurality of shallow slots located along its inner circumference. These shallow slots are adapted to receive wingless wire nuts of various sizes and engage with small grooves or ridges found on many wire nuts, with or without wings. The wire nut aperture also includes a plurality of pairs of deeper slots intermixed with the shallow slots. These slots are arranged in pairs spaced on opposite sides of a central opening across from one another to accommodate a plurality of different sized wire nuts having wings.

In this first embodiment, the handle rotates freely relative to the holder body. In one instance, the shaft of the present invention is connected to the handle via a rotatable connector. The rotatable connector is preferably a “C” type washer or clamp that is coupled within a recess in the handle near the distal end of the shaft. The “C” type washer allows the shaft to spin freely within the handle on the inner surface of the “C” type washer. Otherwise, the shaft may comprise a flared end having a larger diameter than the remaining portion of the shaft. Additionally, the holder in the preferred embodiment is injection molded from nylon with the shaft integrally coupled within the nylon.

The wire nut holder preferably comprises nonconductive materials to protect the user from the potential risk of electrical shock. In one instance, the holder body may be formed from a molded plastic or composite material. The free end of the handle includes a comfortable grip comprising rubber or other nonconductive material.

In an additional embodiment of the invention, the wire nut holder is provided with a square shaft aperture for accepting an end of a socket drive handle. In this manner, the wire nut holder may be coupled with a reversible socket drive or handle for use in installing and/or removing wire nuts. The phrase “socket drive handle” refers to a known ratcheting mechanism, for example a ratcheting driver as set forth in U.S. Pat. No. 7,421,772 to Gao et al. which is incorporated herein by reference thereto.

In a third embodiment, the wire nut tool is provided with a third opening that is preferably arranged between the wire nut aperture and where the handle is coupled to the tool body to receive a shaft having a first end formed as a screw driver head or socket drive. It should be recognized that square shaft aperture for accepting tools such as screwdriver heads and nut drivers may be arranged at various locations on the opposite face of the holder body.

It is an object of the invention to reduce risk of fire associated with a loose wire nut and faulty electrical connection by providing a tool that assists an electrician in installing a wire nut connector.

It is an object of the invention to teach a device that ensures electrical conductivity of an electrical connection between at least two power supplying wires.

It is an object of the invention to reduce the risk of adverse health conditions being experienced by electricians where such adverse conditions are caused by the continual twisting of the hand at the wrist to connect wires using wire nut connectors.

Further objects, features and advantages of the invention will become apparent from a consideration of the following description and the included claims when taken in connection with the previous discussion and the accompanying drawings. The above explanations are provided to illustrate the utility of the invention. And, by no means necessary are these explanations intended to limit the application of this invention from being used for other purposes.

### DESCRIPTION OF THE DRAWINGS

FIG. 1 shows a partial cross section view of the first embodiment of the invention wherein the tool includes a rotating handle having a first end that includes a C-clamp arranged within an opening in the handle to hold the handle in a rotatable relationship to the shaft.

FIG. 2 is taken from a distal end view of the tool and shows a face of the holder body with a wire nut orifice in the first embodiment of the invention.

FIG. 3 shows a first distal orifice having stepped shoulders for accommodating the wings of modern wire nuts.

FIG. 4 shows a second distal orifice for accommodating the wings of modern wire nuts.

FIG. 5A is a second embodiment of the invention shown from the proximal end and having a square opening for accommodating an end of a socket wrench or ratcheting screwdriver handle. FIG. 5B shows a partial cross section view of the holder body of the device with a ratcheting screw driver handle attached thereto.

FIG. 6A shows a third embodiment of the invention taken from the distal end and having a central opening for accepting a tool such as a screwdriver tip or nut driver tip. FIG. 6B shows a partial cross section view of the holder body of the device with a ratcheting screw driver handle attached thereto. FIG. 6C shows a screwdriver tip arranged in front of the distal face of the tool. FIG. 6D shows a screwdriver tip inserted into the central opening.

FIG. 7 shows two types of prior art wire nuts that may be used in connection with the invention.

### DETAILED DESCRIPTION OF THE INVENTION

The following is the preferred embodiment or best mode for carrying out the invention. It should be noted that this invention is not limited by the discussion of the various embodiments and should only be defined by the appended claims. Moreover, it should be recognized that this invention is not limited by the discussion of the preferred embodiments, but that skilled artisans may easily recognize that certain modifications may be made without deviating from the spirit of the invention.

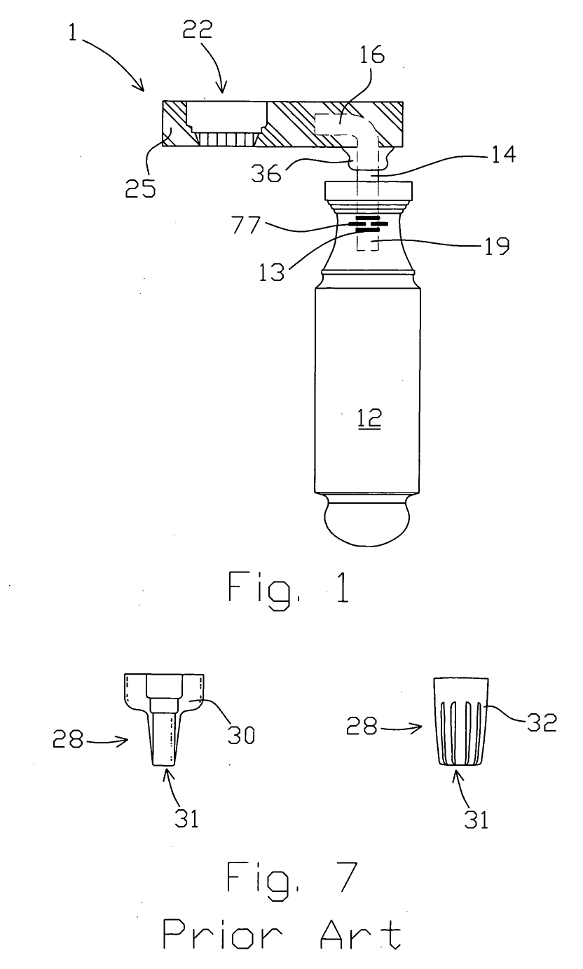

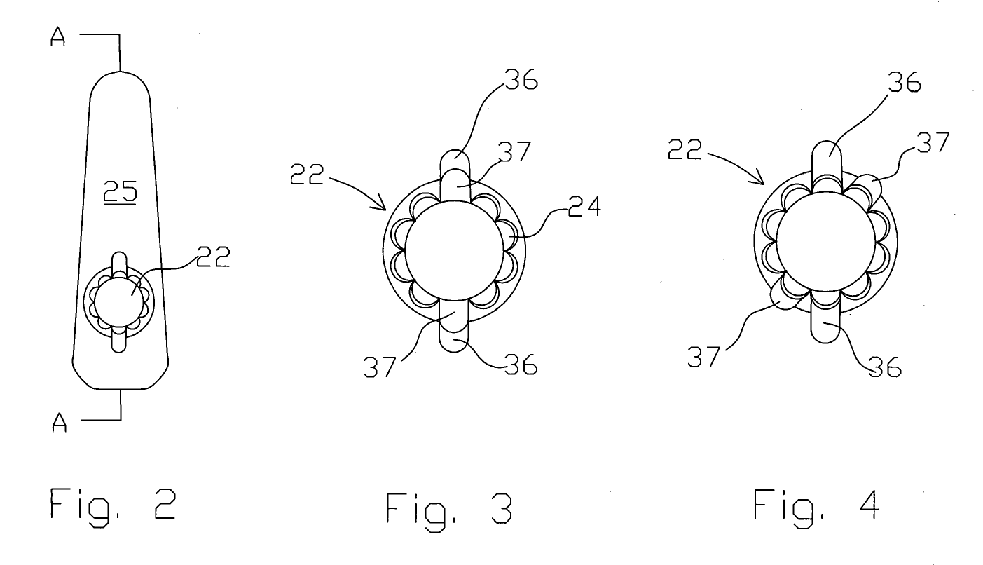

FIG. 1 shows a first embodiment of the invention wherein the tool 1 includes a rotating handle 12 and is taken from line A-A of FIG. 2. As can be understood, wire nuts 28, 28′, shown in FIG. 7, are inserted with closed end 31 into an orifice 22 of body 25. Orifice 22 includes specially arranged regions for either gripping the ridges/grooves 32 provided on wire nut 28′ or accommodating the wings 30 provided on wire nut 28. In this instance, the orifice 22 is larger in diameter on the distal face of the tool 10 than the proximal face. Shaft 14 includes bent end 16 and handle end 19 that may include a shaft collar 13 for accepting a c-clamp 77 to secure the handle 12 to shaft 14 in a free spinning manner. That is, the handle end 19 of the shaft rotates freely relative to the handle 12. Device 1 may be easily spun about an end of two or more wires in a quick fashion to install a wire nut. Otherwise, the wire nut orifice 22 may be arranged around a wire nut and the nut may be spun in a counterclockwise direction to remove the wire nut. In a preferred embodiment, body 25 is formed from a plastic material that is easily formed and is nonconductive. The shaft 14 is preferably formed from metal. The handle 12 includes a rubber grip and is formed from nonconductive material. The handle includes a shaft opening that accepts the straight end of the shaft. Thereafter, the clamp 77 is secured about collar 13 to prevent the handle 12 from slipping off of the shaft 14. In this manner, the shaft 14 and handle 12 are coupled together in a rotatable manner. As can be recognized from the drawing, the body 25 is substantially uniform in thickness from the proximal to distal end. A cap 36 is provided for ornamental purposes.

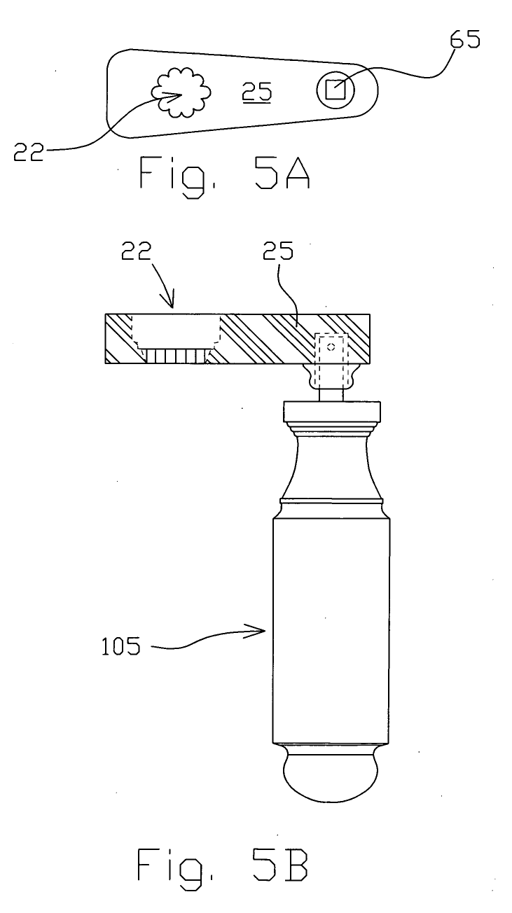

FIG. 2 shows a distal face and end of the tool 1. The tool includes the wire nut orifice 22 having curved regions 24 that mate with the ridges/grooves 32 of wire nut 28′. As can be better understood by FIG. 3, the orifice 22 also includes pairs of stepped ridges 36, 37 that are arranged symmetrical to one another and for accommodating wings on standard yellow and red wire nuts. Where the terms yellow and red are understood to be the most common wire nuts used by electricians in the art, it should be realized that other sizes may be provided. In FIG. 3, the stepped ridges 36, 37 are aligned with one another as shown. In FIG. 4, the stepped ridges 36 and 38 are provided out of phase with one another as shown.

FIGS. 5A and 5B show an additional embodiment of the tool 1 where the proximal face and edge of the tool 1 includes a drive opening 65 for accepting an end of a ratcheting drive 105. As shown in FIG. 5B, the tool 1 may be coupled to a one-quarter inch driver handle 105 or other such ratcheting drive device.

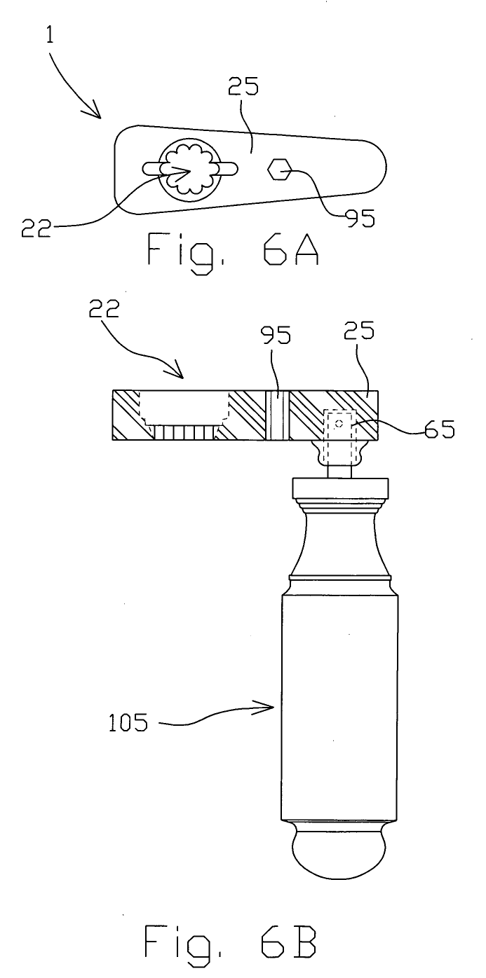

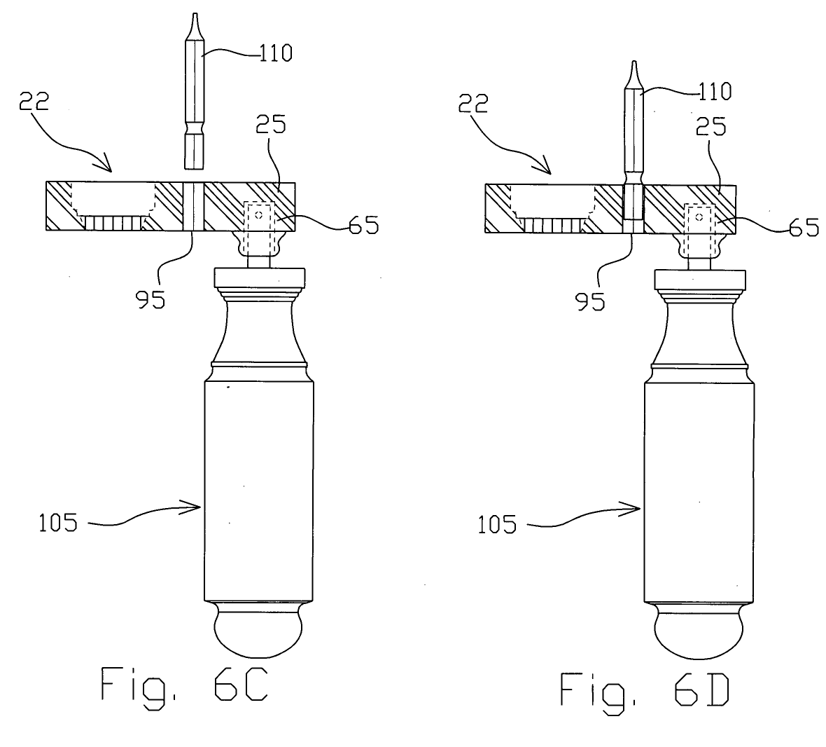

FIGS. 6A-6D show a further embodiment of the invention where an additional opening 95 is provided in the distal face of the tool 1, as clearly shown in FIG. 6A. Opening 95 is preferably a hexagon shaped orifice. As can be understood by FIGS. 6B-6D, a tool 110, shown in the figures as a screwdriver tip, may be inserted to the opening 95 as shown. Sockets or other nut drivers may be inserted into the opening 95. Screws or other nuts may be installed or removed with the tool inserted into the opening 95. The opening 95 is arranged substantially midway between the opening 65 which receives an end of the ratcheting drive and the wire nut opening 22. As with the wire nut opening, by providing the opening 95 offset to the handle, a greater torque may be exerted on screws or nuts when installing or removing them. When used, a wire nut is deposited into the wire nut aperture and wires are inserted into the open end of the wire nut. Thereafter, the body of the tool is rotated in a clockwise manner such that the handle spins counter-clockwise to the body. To remove a wire nut, the wire nut aperture is placed atop a wire nut and rotated in a counter-clockwise manner. This in turn causes the handle to rotate in a clockwise manner with respect to the body.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A wire nut tool that accepts a wire nut which couples at least two conductors together, said wire nut tool comprising:
a handle that rotates in an arcuate path about the wire nut when installing the wire nut onto the two conductors;
a shaft having a first end and a second end, said first end coupled to said handle;
a body having a first end and a second end, said body further connected to the second end of the shaft substantially near the first end of the body such that said handle may rotate freely with respect to the body, a wire nut aperture arranged substantially away from the first end to receive a wire nut such that the handle is offset from the wire nut aperture to create a torque on the wire nut when installing or removing it.

2. The wire nut tool of claim 1 wherein said body is formed from plastic.

3. The wire nut tool of claim 1 wherein said body is formed from nylon.

4. The wire nut tool of claim 1 wherein said wire nut aperture comprises a plurality of curved regions that mate with ridges and grooves on an exterior surface of the wire nut.

5. The wire nut tool of claim 1 wherein said wire nut aperture comprises pairs of stepped ridges that are arranged symmetrical to one another for accommodating wings on an exterior of the wire nut.

6. The wire nut tool of claim 1 wherein said first end of the shaft comprises a collar that receives a c-clamp to secure the handle to the shaft such that the handle may freely rotate with respect to the body.

7. The wire nut tool of claim 1 further comprising an opening arranged in the body between the wire nut aperture and a point where the shaft is coupled to the body.

8. A wire nut tool that twists a wire nut onto a plurality of conductors, said wire nut tool comprising:
a tool body having a first end that comprises an aperture which receives the wire nut, said aperture comprising a plurality of stepped regions that accept one of either grooves or wings arranged on an exterior of said wire nut, said tool body further comprising a second end;
a shaft comprising a first end coupled to the second end of the tool body, said shaft including a second end having a collar;
a handle having a shaft opening that receives said second end of the shaft such that said collar is arranged within the handle; and,
a c-clamp arranged about said collar to prevent the second end of the shaft from sliding through the shaft opening in the handle.

9. The wire nut tool of claim 8 wherein said tool body is formed from plastic.

10. The wire nut tool of claim 8 wherein said tool body is formed from nylon.

11. The wire nut tool of claim 9 wherein said wire nut aperture comprises pairs of stepped ridges that are arranged symmetrical to one another for accommodating wings on an exterior of the wire nut.

12. The wire nut tool of claim 8 wherein said first end of the shaft comprises the collar that receives the c-clamp to secure the handle to the shaft such that the handle may freely rotate with respect to the body.

13. The wire nut tool of claim 1 further comprising an opening arranged in the body between the wire nut aperture and a point where the shaft is coupled to the body.

14. A wire nut tool that twists a wire nut onto a plurality of conductors, said wire nut tool comprising:
a tool body having a first end that comprises an aperture which receives the wire nut, said aperture comprising a plurality of stepped regions that accept one of either grooves or wings arranged on an exterior of said wire nut, said tool body further comprising a second end having a shaft opening; and,
a ratchet handle comprising a ratcheting mechanism having a first end that is inserted into the shaft opening.

15. The wire nut tool of claim 14 wherein said body is formed from plastic.

16. The wire nut tool of claim 14 wherein said body is formed from nylon.

17. The wire nut tool of claim 14 further comprising an opening arranged in the body between the wire nut aperture and a point where the shaft is coupled to the body.
